(19) United States
(12) Patent Application Publication
(10) Pub. No.: US 2021/0287443 A1
(43) Pub. Date: Sep. 16, 2021

(54) POSITIONING OF A VIRTUAL OBJECT IN AN EXTENDED REALITY VIEW

(71) Applicant: Tobii AB, Danderyd (SE)

(72) Inventor: Sourabh PATERIYA, Danderyd (SE)

(73) Assignee: Tobii AB, Danderyd (SE)

(21) Appl. No.: 16/915,124

(22) Filed: Jun. 29, 2020

(30) Foreign Application Priority Data
Jun. 27, 2019 (SE) 1950804-3

(51) Int. Cl. G06T 19/00; G06F 3/01

(52) U.S. Cl. CPC G06T 19/006; G06F 3/013

(57) ABSTRACT

A system, a head-mounted device, a computer program, a carrier and a method for positioning of a virtual object in an extended reality view of at least one user are disclosed. In the method gaze points in world space and respective gaze durations for the gaze points are determined for the at least one user by means of gaze-tracking over a duration of time. Furthermore, gaze heatmap data are determined based on the determined gaze points and respective gaze durations, and the virtual object is positioned in the extended reality view in world space based on the determined gaze heatmap data.

### CROSS REFERENCE TO RELATED APPLICATIONS

This application claims priority to Swedish Application No. 1950804-3 filed Jun. 27, 2019; the content of which are hereby incorporated by reference.

### TECHNICAL FIELD

The present disclosure relates to the field of eye tracking. In particular, the present disclosure relates to positioning of a virtual object in an extended reality view.

### BACKGROUND

In some situations a virtual object, such as a notification or other information carrying virtual objects, are (temporarily) introduced on a display of a device, such as a mobile telephone or a computer. For these situations, rules are generally provided determining where and how the virtual objects are to be introduced. The rules may relate to when a virtual object can be introduced on the display and where and how they are introduced. Furthermore, a notification or other information carrying virtual object introduced on the display may be accompanied with an audio signal or a tactile signal in order to attract a user's attention.

For extended reality (XR), such as augmented reality (AR), augmented virtuality (AV), and virtual reality (VR), the extended reality view of the user will differ depending on how the head of the user is oriented and if the user moves. The rules used in relation to applications without extended reality functionality, such as for mobile telephones and computers, will in many cases not result in a desired effect in application including extended reality functionality. For example, the virtual object may then be positioned such that it interferes with other relevant information or in other ways disturb or distract the view of the user to an unjustified extent.

Hence, enhanced devices and methods for positioning a virtual object in an extended reality view are desirable.

### SUMMARY

An object of the present disclosure is to mitigate, alleviate, or eliminate one or more of the above-identified deficiencies in the art and disadvantages singly or in any combination.

This object is obtained by a method, a system, a head-mounted device, a computer program and a carrier as defined in the independent claims.

According to a first aspect, a method for positioning of a virtual object in an extended reality view of at least one user is provided. In the method gaze points in world space and respective gaze durations for the gaze points are determined for the at least one user by means of gaze-tracking over a duration of time. Furthermore, gaze heatmap data are determined based on the determined gaze points and respective gaze durations, and the virtual object is positioned in the extended reality view in world space based on the determined gaze heatmap data.

Extended reality generally refers to all combinations of completely real environments to a completely virtual environment. Examples are as augmented reality, augmented virtuality, and virtual reality. However, for the present disclosure, examples include at least one virtual object to be positioned in the extended reality view of the user.

A virtual object refers, in the present disclosure, to an object introduced in a field of view of a user and which is not a real world object. The virtual object may for example be a text field, other geometric object or image of a real world object etc.

A gaze point is in the present disclosure a point where the user is gazing. It encompasses both a point in three dimensional space where the user is focusing and also any point along a gaze vector of the user, e.g. a point where the gaze vector crosses a two dimensional plane in the field of view of the user.

Gaze heatmap data are determined based on the gaze points in world space of the at least one user and the duration the at least one user has gazed at each of the gaze points over a duration in time. Hence, the heatmap data may provide a measure of for each gaze point of the importance of the gaze point, and/or a likelihood that the user will gaze at the gaze point again.

This measure may be used to determine where to position a virtual object in the extended reality view in world space. For example, the virtual object may be positioned in relation to how important it is that the at least one user notes the virtual object fast. At the same time it may be positioned such that it does not interfere with other relevant information or in other ways disturbs or distracts the view of the at least one user to an unjustified extent.

In the present disclosure, world space refers to a space, usually three dimensional, such as the real world in case of an augmented reality application, or a virtual world in case of a virtual reality application, or a mixture of both. Positioning the virtual object in the extended reality view in world space refers to positioning the virtual object such that it is essentially locked in relation to world space in the field of view of the user. This means that the perspective changes based on where the user looks at the virtual object from either physically or virtually depending on application.

The present disclosure is at least partly based on the realization that a virtual object to be positioned in an extended reality view of at least one user should be positioned in world space, i.e. such that it is locked in relation to coordinates of the world space the user is in. Furthermore, the virtual object should be positioned in a position in world space based on data indicating the likelihood of the user gazing at that position. Using gaze-tracking over a duration of time, gaze points in world space and respective gaze durations are determined, and data in the form of gaze heatmap data are determined based on the determined gaze points and respective gaze durations. The gaze heatmap data indicating the likelihood of the user gazing at that position. The virtual object is then positioned in the extended reality view in world space based on the determined gaze heatmap data. The virtual object may then be positioned such that it is likely to be noted by the user. Furthermore, the positioning may also take into account a desire for the virtual object not interfering with other relevant information or in other ways disturbing or distracting the view of the user to an unjustified extent.

In embodiments, a region of interest of the extended reality view is identified based on the determined gaze heatmap data. Furthermore, positioning the virtual object comprises positioning the virtual object in the region of interest.

In further embodiments, identifying a region of interest comprises identifying the region of interest of the extended reality view based on determined gaze points with gaze durations above a threshold. For example, important virtual objects such as an important notification, may be positioned in a region of interest including gaze points at which the at least one user has been gazing for a duration longer than the threshold.

In embodiments, the method further comprises identifying at least two regions of interest of the extended reality view based on the determined gaze heatmap data, and defining at least two priorities for virtual objects. The at least two priorities are then mapped to the at least two regions of interest. A priority of the at least two priorities of a virtual object is obtained, and the virtual object is positioned in one of the at least two regions of interest based on the obtained priority and the mapping. For example, different priority virtual objects may be positioned in corresponding regions of interest.

In further embodiments, identifying at least two regions of interest of the extended reality view comprises identifying a first region of interest of the at least two regions of interest based on determined gaze points with gaze durations above a threshold, and identifying a second region of interest of the at least two regions of interest based on determined gaze points with gaze durations below the threshold. Mapping the at least two priorities further comprises mapping a higher priority of the at least two priorities to the first region of interest, and mapping a lower priority of the at least two priorities to the second region of interest. The virtual object is then positioned in one of the at least two regions of interest based on the obtained priority and the mapping, such that a higher priority virtual object is positioned in the first region of interest and a lower priority virtual object is position in the second region of interest.

In some embodiments, further gaze points in world space and respective further gaze durations for the further gaze points are determined for at least one further user by means of eye-tracking over a duration of time, and the gaze heatmap data are determined based on the determined gaze points and respective gaze durations of the at least one user and the determined further gaze points and respective further gaze durations of the at least one further user.

According to a second aspect, a system comprising a processor, a display, and a memory is provided. The memory contains instructions executable by the processor, whereby the system is operative to determine, for the at least one user, gaze points in world space and respective gaze durations for the gaze points by means of gaze-tracking over a duration of time. Gaze heatmap data are determined based on the determined gaze points and respective gaze durations, and the virtual object is positioned in the extended reality view in world space based on said determined gaze heatmap data.

Embodiments of the system according to the second aspect may for example include features corresponding to the features of any of the embodiments of the method according to the first aspect.

According to a third aspect, a head mounted device is provided comprising the system of the second aspect.

Embodiments of the head-mounted device according to the third aspect may for example include features corresponding to the features of any of the embodiments of the system according to the second aspect.

According to a fourth aspect, a computer program is provided. The computer program comprises instructions which, when executed by at least one processor, cause the at least one processor to determine gaze points in world space and respective gaze durations for the gaze points for at least one user by means of gaze-tracking over a duration of time. Furthermore, gaze heatmap data are determined based on the determined gaze points and respective gaze durations, and a virtual object is positioned in the extended reality view in world space based on said determined gaze heatmap data.

Embodiments of the computer program according to the fourth aspect may for example include features corresponding to the features of any of the embodiments of the method according to the first aspect.

According to a fifth aspect, a carrier comprising a computer program according to the third aspect is provided. The carrier is one of an electronic signal, optical signal, radio signal, and a computer readable storage medium.

Embodiments of the carrier according to the fifth aspect may for example include features corresponding to the features of any of the embodiments of the method according to the first aspect.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIGS. 1a and 1b is a flowchart illustrating embodiments of a method according to the present disclosure.

FIG. 2 is a block diagram illustrating embodiments of a system according to the present disclosure.

FIGS. 3a and 3b show a head-mounted device and a remote display system, respectively, according to one or more embodiments of the present disclosure.

FIGS. 4a and 4b are visual illustrations of gaze heatmap data in relation to a single user and positioning of a virtual object based on gaze heatmap data.

FIGS. 5a and 5b are visual illustrations of gaze heatmap data in relation to multiple users and positioning of a virtual object based on gaze heatmap data.

All the figures are schematic, not necessarily to scale, and generally only show parts which are necessary in order to elucidate the respective example, whereas other parts may be omitted or merely suggested.

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the invention. As used herein, the singular forms “a”, “an” and “the” are intended to include the plural forms as well, unless the context clearly indicates otherwise.

In the following, descriptions of examples of methods and devices for positioning of a virtual object in an extended reality view of at least one user are provided. Generally, virtual objects in an extended reality application can be positioned in relation to world space, i.e. in relation to coordinates in a world space to which the extended reality application relates. As such, if the virtual object positioned in a field of view of a user of an extended reality device is to appear to be static in world space, it will not be positioned in a static position on one or more display of the extended reality device. Instead, the virtual object will be moved around on the one or more displays when the user changes position and/or turns her or his head in order to make the virtual object appear as if it is positioned fixed in world space. This is different from positioning a virtual object, such as a notification, on a display of a device without extended reality functionality. In devices without extended reality functionality virtual objects, such as notifications, are positioned on a display according to their priority. Also, in order to further attract a user's attention, a notification or other information carrying virtual object introduced on the display may be accompanied with an audio signal or a tactile signal in order to attract a user's attention. As displays are normally limited in size this will typically enable the user to identify the virtual object on the display after noting the audio or tactile signal. For an application where virtual objects are to be positioned in an extended reality view of a user, the rules used in relation to applications without extended reality functionality, such as mobile telephone and computer devices, will in many cases not result in a desired effect. For example, the virtual object may then be positioned such that it interferes with other relevant information or in other ways disturb or distract the view of the user to an unjustified extent. Furthermore, the number of options of where to position a virtual object in an extended reality view is immense. For example, the view of the user will differ depending on how the head of the user is oriented and if the user moves. Audio and tactile signals are also not as suitable for virtual objects in an extended reality view as for devices where the display on which the virtual object is shown and the means for generating the audio or tactile signals are co-located.

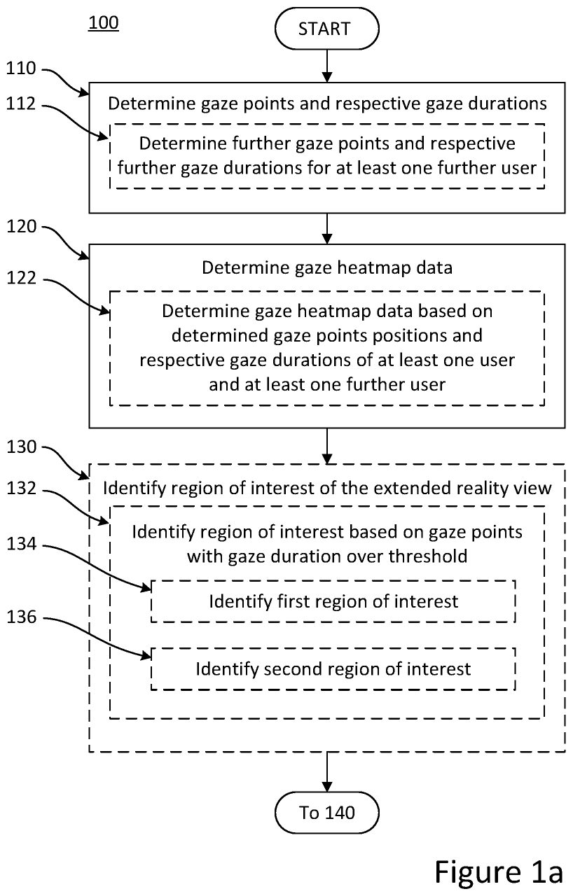

Figures 1a and 1b is a flowchart illustrating embodiments of a method 100 for positioning of a virtual object in an extended reality view of at least one user. The method 100 may for example be performed in a system implementing gaze-tracking functionality and extended reality functionality, such augmented reality or virtual reality functionality. In the method 100, gaze points in world space and respective gaze durations for the gaze points are determined 110 for the at least one user by means of gaze-tracking over a duration of time. This is for example implemented by tracking the at least one users gaze over the duration of time and recording the duration which the at least one user gazes at each gaze point. If the at least one user returns to a gaze point during the duration of time, the gaze duration in relation that gaze point is accumulated. Furthermore, gaze heatmap data are determined 120 based on the determined gaze points and respective gaze durations, and the virtual object is positioned 170 in the extended reality view of the at least one user in world space based on the determined gaze heatmap data.

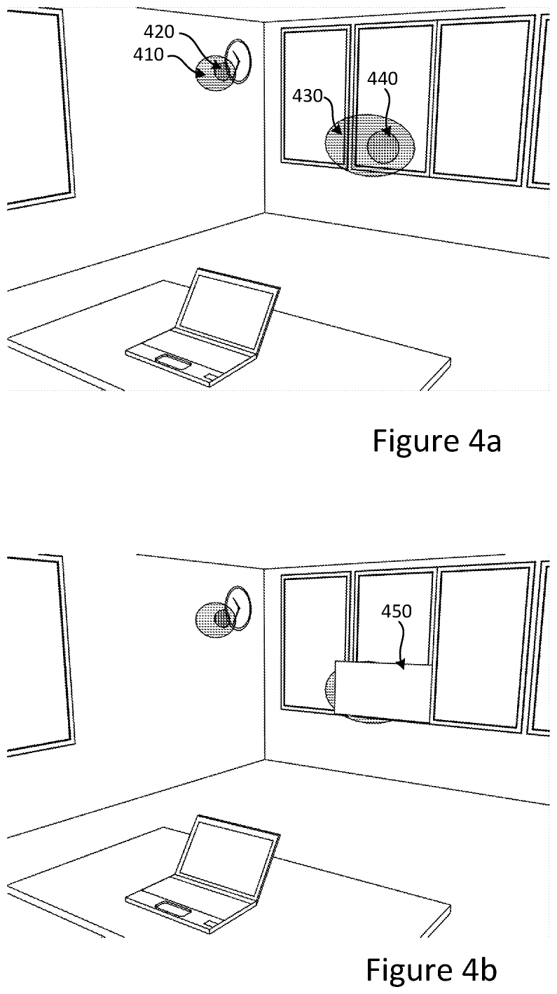

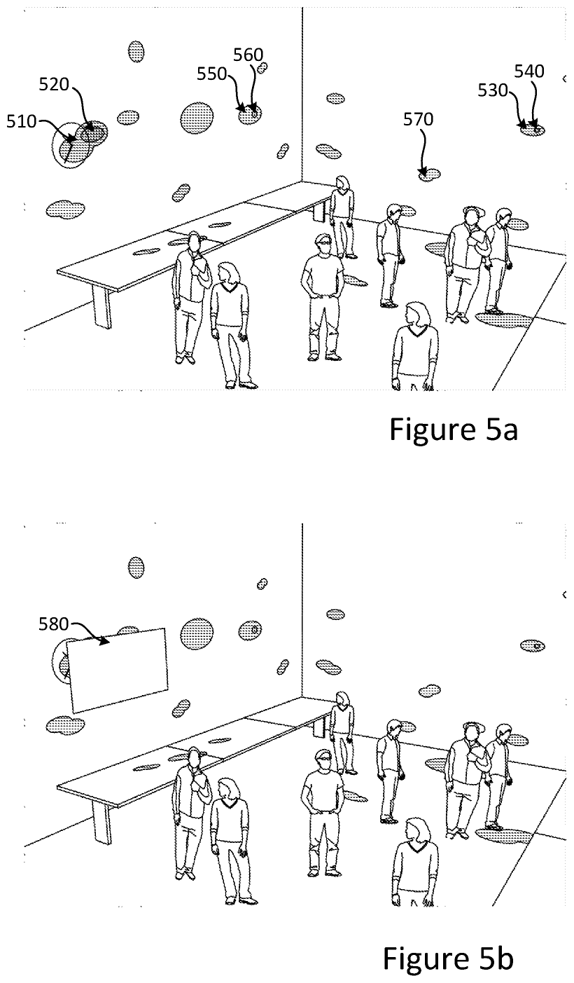

The concept gaze heatmap data is used to denote data that in some way provides a measure for gaze points of the importance of the gaze points in terms of being gazed on by the at least one user. Over time, a pattern of where and how long the at least one user gazes is identified and described by the gaze heat map data (see further FIGS. 4a and 4b and FIGS. 5a and 5b). It is assumed that the pattern is not random but based on repetitive behaviour of the at least one user. The gaze heatmap data are also assumed to provide information of a likelihood that the user will gaze at the gaze point again based on this pattern indicated by the gaze heatmap data based on historical gaze data. This measure may be used to determine where to position a virtual object in the extended reality view in world space. For example, the virtual object may be positioned in relation to how important it is that the at least one user notes the virtual object fast after positioning. At the same time it may be positioned such that it does not interfere with other relevant information or in other ways disturbs or distracts the view of the at least one user to an unjustified extent. For example, the virtual object may be positioned in a position where the at least one has gazed for a 1arge portion of the duration of time. This would generally lead to the at least one user identifying the virtual object fast after it has been positioned. In alternative, it may be position close to but not overlapping a position where the at least one has gazed for a 1arge portion of the duration of time. By being close to such a position, e.g. within a distance such that the virtual object is noted even if the at least one user is not looking directly at it. This would generally lead to the at least one user identifying the virtual object fast after it has been positioned. At the same time, since the virtual object is not overlapping the position where the at least one has gazed for a 1arge portion of the duration of time, any object at such a position which is of interest for the user is not occluded by the virtual object.

In some examples, the gaze points and respective gaze durations are only maintained for the duration of time. Gaze points and respective gaze durations which occurred more than the duration of time ago are not taken into account when determining the gaze heatmap data. The length of the duration of time, or the amount of time, which the gaze points and the respective gaze durations are determined and used for determining gaze heatmap data may depend on the application or on specific parameters. For example, if the user moves, gaze points and respective gaze durations may not be relevant in relation to positioning the virtual object after a rather short duration of time. On the other hand if the user is not moving around much, gaze points and respective gaze durations may be relevant also after a rather long duration of time.

Other parameters can also affect the length of the duration of time taken into account when determining gaze heatmap data. Also, as an alternative of not taking account to old gaze positions and respective gaze durations could be to add weights to the gaze positions and gaze durations such that more recent gaze points would have a higher weight when determining gaze heatmap data.

Depending on the application, the virtual object to be positioned may be of many different types. Typically, it is an object that a user is intended to note and possibly interact with. The urgency of the user noting the virtual object may vary. For example, the virtual object may be a notification of some type, such as a text field providing information. It may also be some other geometric object or image of a real world object or other, which may provide direct information to the user or may indicate that there are information to the user which could be accessed by interaction with the object such as by focusing on the object for a predetermined duration of time. It is to be noted, that the type of virtual object is not essential to the present disclosure. Rather, the present disclosure aims to, at least to some extent, control the likelihood that the user notes the virtual object and to avoid that the virtual object interferes with other relevant information or in other ways disturb or distract the view of the user to an unjustified extent.

Determining a gaze point of a user is generally performed by means of gaze-tracking by determining gaze direction or gaze vectors of the users eyes and a convergence distance which is the distance where the gaze directions or gaze vectors of the users eyes converge, i.e. where the user is focusing. Depending on for example the application, and on user behaviour, the gaze points can either be determined as three dimensional coordinates in world space or it may be determined as two dimensional coordinates in world space.

For example, if the user maintains more or less the same position and possibly maintains gaze directions within 180° angle over a longer period of time, e.g. by sitting or standing still at an office desk or the like, gaze points can be determined along gaze directions or gaze vectors of the users eyes where they cross an imaginary plane in front of the user, such that the exact convergence distance need not be determined. Gaze heatmap data can then be determined relating to the imaginary plane and a virtual object can be positioned based on such gaze heatmap data, e.g. somewhere in the plane. The gaze heatmap data will reflect that the user's gaze position will vary according to a pattern which depends on the user's behaviour. The user's behaviour relates to the user gazing at different positions in world space during different portions of time. For this situation, the user's position is maintained. Hence, even if the user's behaviour relates to the user gazing at different positions in world space during different portions of time, the same position in world space will always result in the same or very similar gaze direction.

For situations where the user only maintains the same position for very short periods of time or is constantly moving around such that the user gazing on the same object at different times relates to different gazing directions or gazing vectors, gaze points should preferably be determined based on both gaze direction and gaze convergence distance. Gaze heatmap data can then be determined relating to the actual objects in three dimensional space. If a user gazes at a gaze point from a position at an angle for a first gaze duration at a first time and then within the duration of time returns to the gaze point from a different position at a different angle for a second gaze duration, the gaze heatmap data are in this example determined based on the gaze point and the first gaze duration plus the second gaze duration. The gaze heat map will reflect that the user's gaze position will vary according to a pattern which depends on the user's behaviour. The user's behaviour relates to the user gazing at different positions in world space during different portions of time. For this situation, the user does not maintain the same position. Hence, gazing at the same position in world space will not always result in the same gaze direction.

In alternative, for situations where the user only maintains the same position for very short periods of time or is constantly moving around such that the user gazing on the same object at different times relates to different gazing directions or gazing vectors, gaze points could be determined as any point along a gaze vector of the user. When the origin of the gaze vector is changed (for example by the user moving the gaze origin) it will be obvious from the heatmap data that only a limited number of gaze points along the gaze vectors are overlapping and, thus, those limited number of gaze points will be gazed at during a longer time period. The method 100 may further comprise identifying 130 a region of interest of the extended reality view based on the determined gaze heatmap data. The virtual object is then positioned 172 in the region of interest. The region of interest is typically a region which fulfils a requirement in relation to the likelihood of the user gazing in the region of interest. For example, the region of interest of the extended reality view can be identified 132 based on determined gaze points with gaze durations above a threshold. Depending on the size of the threshold, gaze points with gaze durations above the threshold are gaze points which the user may look at for a substantial portion of the duration of time. The region of interest including such gaze points, will hence be regions in which the user looks for a substantial portion of the duration of time. The exact form of the region of interest is selected such that a virtual object positioned in the region of interest will generally be noted by the user if the user gazes at one of the gaze points with gaze durations above a threshold.

The method 100 may further comprise identifying 134, 136 at least two regions of interest of the extended reality view based on the determined gaze heatmap data, and defining 140 at least two priorities for virtual objects. The at least two priorities are then mapped 150 to the at least two regions of interest. Typically, a high priority is mapped to a region of interest in which a virtual object is likely to be noted by the user and a low priority is mapped to another region of interest in which a virtual object is may be less likely to be noted by the user. For a virtual object to be positioned, a priority of the at least two priorities is obtained 160. Based on the obtained priority and the mapping, the virtual object is positioned 172. Further levels of priority of virtual objects can be defined and further regions of interest to which the further levels of priority are mapped.

One way of identifying at least two regions of interest of the extended reality view is to identify 134 a first region of interest of the at least two regions of interest based on determined gaze points with gaze durations above a threshold. A second region of interest of the at least two regions of interest may then be identified 136 based on determined gaze points with gaze durations below the threshold. A higher priority of the at least two priorities is mapped 150 to the first region of interest, and a lower priority of the at least two priorities is mapped 150 to the second region of interest. The virtual object is then positioned 172 in one of the at least two regions of interest based on the obtained priority and the mapping, such that a higher priority virtual object is positioned in the first region of interest and a lower priority virtual object is position in the second region of interest. For example, important virtual objects, such an important notification, may be given a higher priority and be positioned in the first region of interest including gaze points at which the at least one user has been gazing for a duration longer than the threshold. Less important virtual objects such a less important notification, may be given a lower priority and be positioned in the second region of interest including gaze points at which the at least one user has been gazing for a duration shorter than the threshold. Higher priority virtual objects may be positioned such that the at least one user notes them fast and may be allowed to interfere with other relevant information or in other ways disturbs or distracts the view of the user to some extent considered to be justified in relation to their importance. On the other hand, lower priority virtual objects may be instead be positioned such that the at least one user notes them after a longer time and may not be allowed to interfere with other relevant information or in other ways disturbs or distracts the view of the user to any 1arge extent since this is not considered to be justified in relation to their importance.

Three or more levels of priority of virtual objects can be defined and three or more respective regions of interest to which the three or more levels of priority are mapped. For example, for three levels of priority and three regions of interest, a first region of interest can be defined based on determined gaze points with gaze durations up to a first threshold, a second region of interest based on determined gaze points with gaze durations between the first threshold and a second threshold, and a third region of interest base on determined gaze points with gaze durations over the second thresholds. The three priorities can then be mapped to a respective region of interest.

In a further example, a virtual object should be positioned in extended reality views of both the at least one user and at least one further user. Further gaze points in world space and respective further gaze durations for the further gaze points are determined 112 for at the least one further user by means of eye-tracking over the duration of time. The gaze heatmap data are then determined 122 based on the determined gaze points and respective gaze durations of the at least one user and the determined further gaze points and respective further gaze durations of the at least one further user. The virtual object is then positioned in the extended reality view of the at least one user and the at least one further user respectively, in the same position in world space, based on the determined gaze heatmap data.

By determining the gaze map data based on the determined gaze points and respective gaze durations of the at least one user and the determined further gaze points and respective further gaze durations of the at least one further user, the virtual object may be positioned in relation to how important it is that the at least one user and the at least one further user notes the virtual object fast. At the same time it may be positioned such that it does not interfere with other relevant information or in other ways disturbs or distracts the view of the at least one user and the at least one further user to an unjustified extent. In this example, collective gaze heat map data are determined indicating a collective likelihood of the at least one user and the at least one further user looking at different gaze points. In alternative, the virtual object may be positioned based on separate gaze heatmap data for each of plurality of users such that the virtual object may be positioned in different positions in world space for different users.

The gaze points of the at least one user and the determined further gaze points of the at least one further user can be determined based on both gaze direction and gaze convergence distance. Gaze heatmap data can then be determined relating to actual points or objects in three dimensional space. If different users gaze at a gaze point from different positions, the gaze heatmap data may for example determined based on the gaze point and the respective gaze durations of the different users combined.

In alternative gaze points could be determined as any point along the different gaze vectors of the different users. When the origin of the gaze vectors are different it will be obvious from the heatmap data that only a limited number of gaze points along the gaze vectors are overlapping and, thus, those limited number of gaze points will be gazed at during a longer time period.

FIG. 1 comprises some steps that are illustrated in boxes with a solid border and some steps that are illustrated in boxes with a dashed border. The steps that are comprised in boxes with a solid border are operations that are comprised in the broadest example embodiment. The steps that are comprised in boxes with a dashed border are example embodiments that may be comprised in, or a part of, or are further operations that may be taken in addition to the operations of the border example embodiments. The steps do not all need to be performed in order and not all of the operations need to be performed. Furthermore, at least some of the steps may be performed in parallel.

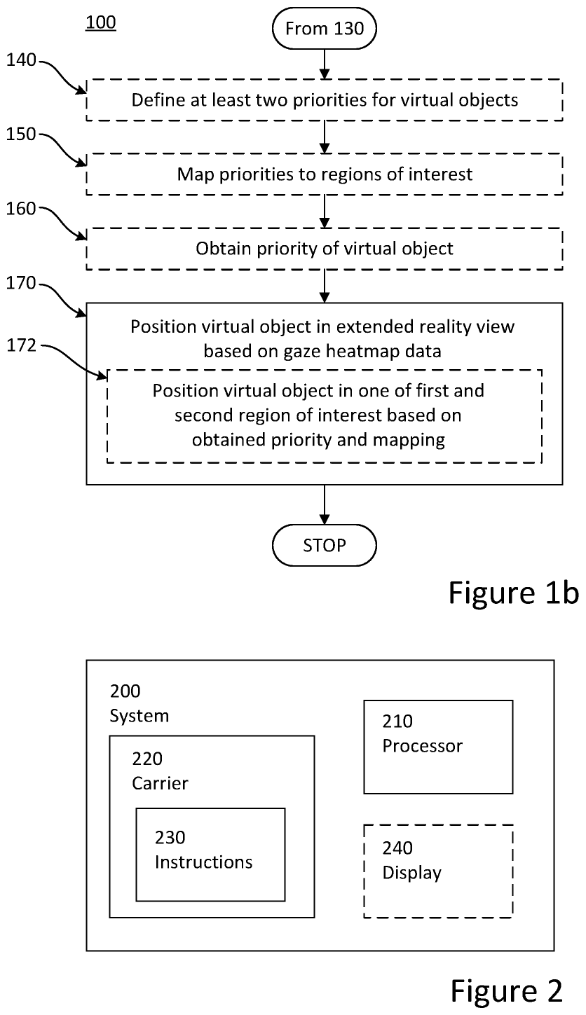

Methods for positioning of a virtual object in an extended reality view of at least one user and steps therein as disclosed herein, e.g. in relation to FIGS. 1a and 1b, may be implemented in a system 200 of FIG. 2. The system 200 includes extended reality and gaze tracking functionality, and comprises a processor 210, and a carrier 220 including computer executable instructions 230, e.g. in the form of a computer program, that, when executed by the processor 210, cause the system 200 to perform the method. The carrier 220 may for example be an electronic signal, optical signal, radio signal, a transitory computer readable storage medium, and a non-transitory computer readable storage medium. Generally, the system will comprise at least one display 240. Virtual objects in an extended reality view of the system can be positioned in relation to world space, i.e. in relation to coordinates in a world space to which the system 200 relates. As such, if the virtual object positioned in a field of view of a user of the system is to appear to be static in world space, it will not be positioned in a static position on the ate least one display 240 of the system 200. Instead, the virtual object will be moved around on the at least one display 240 when the user changes position and/or turns her head in order to make the virtual object appear as if it is positioned fixed in world space.

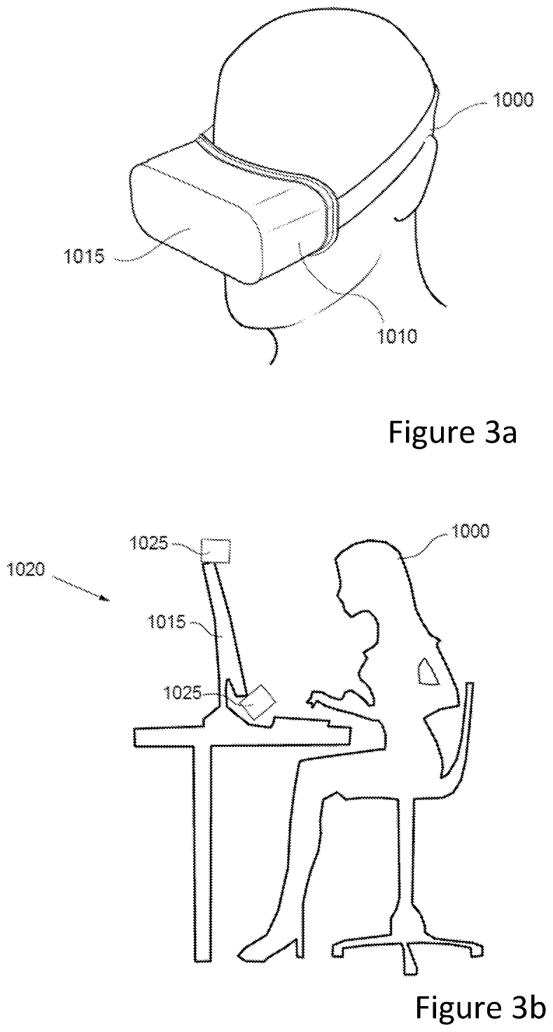

The system 300 may for example be implemented in a head-mounted device as illustrated in FIG. 3a or in a remote display system as illustrated in FIG. 3b.

FIG. 3a shows a head-mounted device 1010 according to one or more embodiments. The head-mounted device 1010, is a device which may optionally be adapted to be mounted (or arranged) at the head of a user 1000, as shown in FIG. 3a. The head-mounted device 1010 may e.g. comprise and/or be comprised in a head-mounted display, HMD, such as a VR headset, an AR headset or an MR headset. The head-mounted device 1010 or HMD comprises a displaying device 1015, which is able to visualize a plurality of objects in response to a control signal received from a computer. The displaying device 1015 may be transparent for real world experiences and non-transparent for virtual world experience. The head-mounted device 1010 is typically further configured to provide eye tracker functionality by a gaze tracking signal using one or more gaze tracking sensors (not shown), e.g. indicative of a gaze direction and/or a convergence distance. In other words, the head-mounted device 1010 is configured to provide an indication of an object the user is looking at and/or a depth at which the user is looking/watching. Preferably, the head-mounted device 1010 comprises one eye tracker for each eye.

The displaying device 1015 may for example be 3D display, such as a stereoscopic display. The 3D display may for example be comprised glasses equipped with AR functionality. Further, the 3D display may be a volumetric 3D display, being either autostereoscopic or automultiscopic, which may indicate that they create 3D imagery visible to an unaided eye, without requiring stereo goggles or stereo head-mounted displays. Consequently, as described in relation to

FIG. 3a, the 3D display may be part of the head-mounted device 1010.

In an alternative embodiment, the displaying device 1015 is a physical display such as a screen of a computer, tablet, smartphone or similar, and the selectable object is displayed at the physical display.

FIG. 3b shows a remote display system 1020 according to one or more embodiments comprising a display device 1015. The remote display system 1020 typically comprises a remote display device 1015 in the form of a 3D display, as described in relation to FIG. 3a. The 3D display is remote in the sense that it is not located in the immediate vicinity of the user 1000. The remote display system 1020 is typically further configured to provide eye tracker functionality by a gaze tracking signal using one or more gaze tracking sensors 1025, e.g. indicative of a gaze direction and/or a convergence distance. In other words, the remote display system 1020 is configured to provide an indication of an object the user 1000 is looking at and/or a depth at which the user is looking/watching. As can be seen from FIG. 3b, the remote 3D display does not require stereo/stereoscopic goggles or stereo/stereoscopic head-mounted displays. In a further example, the 3D display is a remote display, where stereoscopic glasses are needed to visualize the 3D effect to the user. The remote display system 1020 may comprise only one eye tracker for both eyes. In other words, the illuminator(s) and the image device(s) are arranged to illuminate/read both eyes of the user.

FIGS. 4a and 4b are visual illustrations of gaze heatmap data in relation to a single user and positioning of a virtual object based on gaze heatmap data according the present disclosure.

The concept gaze heatmap data are used to denote data that in some way provides a measure for gaze points of the importance of the gaze points in terms of being gazed on by the user. Over time, a pattern of where and how long the user gazes is identified and described by the gaze heat map data. It is assumed that the pattern is not random but based on repetitive behaviour of the user. The gaze heatmap data are assumed to provide information of a likelihood that the user will gaze at the gaze point based on this pattern indicated by the gaze heatmap data based on historical gaze data.

In FIG. 4a, the different filling in the areas 410, 420, 430, 440 may generally indicate a predicted probability that the user will look in the respective area within a period of time, such that the two areas 420, 440 filled with both horizontal and vertical lines may indicate areas 420, 440 in which the user is more likely to gaze within a period of time than in the two areas 410, 430 filled with only horizontal lines. For example, the likelihood may be based on gaze duration at different gaze points or different areas over time. In such a case, the two areas 420, 440 filled with both horizontal and vertical lines may indicate areas 420, 440 where the user has been gazing for a longer gaze duration than the two areas 410, 430 filled with only horizontal lines.

If a virtual object to be positioned in the extended reality view is considered important such that it is desired that the user notes the virtual object fast, the virtual object could be positioned in one of the areas 420, 440 where the gaze heatmap data indicates that it is more likely that the user will look within a period of time, e.g. an area where the user has been gazing for a longer gaze duration. This may be the case illustrated in FIG. 4b, where the virtual object 450 has been positioned over the area 440 close to the window of the areas 420, 440 where it is more likely that the user will look within a period of time, as indicated by the visual illustration of the heatmap data in FIG. 4a, e.g. because the user has been gazing for a longer gaze duration in that area 440 than in other areas.

FIGS. 5a and 5b are visual illustrations of gaze heatmap data in relation to multiple users and positioning of a virtual object based on gaze heatmap data.

In case of multiple users, the concept gaze heatmap data are used to denote data that in some way provides a measure for gaze points of the importance of the gaze points in terms of being gazed on by as many as possible of the multiple users within a period of time or by all of the multiple users within a short a time as possible. Over time, a pattern of where and how long the multiple users gaze is identified and described by the gaze heat map data. It is assumed that the pattern is not random but based on repetitive behaviour of the multiple users. The gaze heatmap data are assumed to provide information of a likelihood that the multiple users will gaze at the gaze point based on this pattern indicated by the gaze heatmap data based on historical gaze data.

In FIG. 5a, the different filling in the areas 510, 520, 530, 540, 560, 570 may generally indicate a predicted probability that the multiple users will look in the respective area within a period of time, such that the areas 520, 540, 560 filled with both horizontal and vertical lines may indicate areas 520, 540, 560 in which the multiple users are more likely to gaze within a period of time than in the areas 510, 530, 550, 570 filled with only horizontal lines. For example, the likelihood may be based on gaze duration at different gaze points or different areas over time for the multiple users. In such a case, the areas 520, 540, 560 filled with both horizontal and vertical lines may indicate areas 520, 540, 560 where the multiple users have been gazing for a longer gaze duration than the areas 510, 530, 550, 570 filled with only horizontal lines.

If a virtual object to be positioned in the extended reality view is considered important such that it is desired that the multiple users note the virtual object fast, the virtual object could be positioned in one of the areas 520, 540, 560 where the gaze heatmap data indicate that it is more likely that the multiple users will look within a period of time, e.g. an area where the multiple users have been gazing for a longer gaze duration. This may be the case illustrated in FIG. 5b, where the virtual object 580 has been positioned over the area 520 close to the clock of the areas 520, 540, 560 where it is more likely that the multiple users will look within a period of time, as indicated by the visual illustration of the heatmap data in FIG. 5a, e.g. because the multiple users have been gazing for a longer gaze duration in that area 520 than in other areas.

It is to be noted that the illustrations in FIGS. 4a and 4b and FIGS. 5a and 5b are only provided for explanatory reasons. In embodiments of the present disclosure, gaze heatmap data are typically used without any indication of them in the extended reality view of the single user or the multiple users.

A person skilled in the art realizes that the present invention is by no means limited to the embodiments described above. On the contrary, many modifications and variations are possible within the scope of the appended claims.

Additionally, variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The terminology used herein is for the purpose of describing particular aspects of the disclosure only, and is not intended to limit the invention. The division of tasks between functional units referred to in the present disclosure does not necessarily correspond to the division into physical units; to the contrary, one physical component may have multiple functionalities, and one task may be carried out in a distributed fashion, by several physical components in cooperation. A computer program may be stored/distributed on a suitable non-transitory medium, such as an optical storage medium or a solid-state medium supplied together with or as part of other hardware, but may also be distributed in other forms, such as via the Internet or other wired or wireless telecommunication systems. The mere fact that certain measures/features are recited in mutually different dependent claims does not indicate that a combination of these measures/features cannot be used to advantage. Method steps need not necessarily be performed in the order in which they appear in the claims or in the embodiments described herein, unless it is explicitly described that a certain order is required. Any reference signs in the claims should not be construed as limiting the scope.

1. Method for positioning of a virtual object in an extended reality view of at least one user, the method comprising:
determining, for the at least one user, gaze points in world space and respective gaze durations for the gaze points by means of gaze-tracking over a duration of time;
determining gaze heatmap data based on the determined gaze points and respective gaze durations; and
positioning the virtual object in the extended reality view in world space based on the determined gaze heatmap data.

2. The method according to claim 1, further comprising:
identifying, based on the determined gaze heatmap data, a region of interest of the extended reality view, and
wherein positioning the virtual object comprises:
positioning the virtual object in the region of interest.

3. The method of claim 2, wherein identifying a region of interest comprises:
identifying the region of interest of the extended reality view based on determined gaze points with gaze durations above a threshold.

4. The method according to claim 1, further comprising:
identifying, based on the determined gaze heatmap data, at least two regions of interest of the extended reality view;
defining at least two priorities for virtual objects;
mapping the at least two priorities to the at least two regions of interest; and
obtaining a priority of the at least two priorities of a virtual object,
wherein positioning the virtual object comprises:
positioning the virtual object in one of the at least two regions of interest based on the obtained priority and the mapping.

5. The method of claim 4, wherein identifying at least two regions of interest of the extended reality view comprises:
identifying a first region of interest of the at least two regions of interest based on determined gaze points with gaze durations above a threshold; and
identifying a second region of interest of the at least two regions of interest based on determined gaze points with gaze durations below the threshold,
wherein mapping the at least two priorities comprises:
mapping a higher priority of the at least two priorities to the first region of interest; and
mapping a lower priority of the at least two priorities to the second region of interest,
and wherein positioning the virtual object comprises:
positioning the virtual object in one of the at least two regions of interest based on the obtained priority and the mapping, such that a higher priority virtual object is positioned in the first region of interest and a lower priority virtual object is position in the second region of interest.

6. The method of claim 1, further comprising:
determining, for at least one further user, further gaze points in world space and respective further gaze durations for the further gaze points by means of eye-tracking over a duration of time, and
wherein determining gaze heatmap data comprises:
determining gaze heatmap data based on the determined gaze points and respective gaze durations of the at least one user and the determined further gaze points and respective further gaze durations of the at least one further user.

7. A system comprising a processor, a display, and a memory, said memory containing instructions executable by said processor, whereby said system is operative to:
determine, for at least one user, gaze points in world space and respective gaze durations for the gaze points by means of gaze-tracking over a duration of time;
determine gaze heatmap data based on the determined gaze points and respective gaze durations; and
position a virtual object in the extended reality view in world space based on said determined gaze heatmap data.

8. The system according to claim 7, further operative to:
identify, based on the determined gaze heatmap data, a region of interest of the extended reality view; and
position the virtual object in the region of interest.

9. The system according to claim 8, further operative to:
identify, based on the determined gaze heatmap data, a region of interest of the extended reality view based on determined gaze points with gaze durations above a threshold.

10. The system according to claim 7, further operative to:
identify, based on the determined gaze heatmap data, at least two regions of interest of the extended reality view;
define at least two priorities for virtual objects;
map the at least two priorities to the at least two regions of interest;
obtain a priority of the at least two priorities of a virtual object; and
position the virtual object in one of the at least two regions of interest based on the obtained priority and the mapping.

11. The system according to claim 10, further operative to:
identify a first region of interest of the at least two regions of interest based on determined gaze points with gaze durations above a threshold;
identify a second region of interest of the at least two regions of interest based on determined gaze points with gaze durations below the threshold;
map a higher priority of the at least two priorities to the first region of interest;
map a lower priority of the at least two priorities to the second region of interest; and
position the virtual object in one of the at least two regions of interest based on the obtained priority and the mapping, such that a higher priority virtual object is positioned in the first region of interest and a lower priority virtual object is position in the second region of interest.

12. The system according to claim 7 further operative to:
determine for at least one further user, further gaze points in world space and respective further gaze durations for the further gaze points by means of eye-tracking over a duration of time; and
determine gaze heatmap data based on the determined gaze points and respective gaze durations of the at least one user and the determined further gaze points and respective further gaze durations of the at least one further user.

13. A head-mounted device comprising a system of claim 7.

14. A computer program, comprising instructions which, when executed by at least one processor, cause the at least one processor to:
determine, for the at least one user, gaze points in world space and respective gaze durations for the gaze points by means of gaze-tracking over a duration of time;
determine gaze heatmap data based on the determined gaze points and respective gaze durations; and
position the virtual object in the extended reality view in world space based on said determined gaze heatmap data.

15. A carrier comprising a computer program according to claim 14, wherein the carrier is one of an electronic signal, optical signal, radio signal, and a computer readable storage medium.
